(19) United States
(12) Patent Application Publication
(10) Pub. No.: US 2025/0346270 A1
(43) Pub. Date: Nov. 13, 2025

(54) HAND TRUCK ASSEMBLY FOR ASSISTED CARGO OFFLOADING

(71) Applicant: James Baltrukonis, Hope Valley, RI (US)

(72) Inventor: James Baltrukonis, Hope Valley, RI (US)

(21) Appl. No.: 19/208,514

(22) Filed: May 14, 2025

Related U.S. Application Data
(60) Provisional application No. 63/731,519, filed on May 13, 2024.

(51) Int. Cl. B62B 1/14; B62B 1/12

(52) U.S. Cl. CPC B62B 1/145; B62B 1/12

(57) ABSTRACT

The present invention is directed to pivot and linkage systems and devices for assisted cargo unloading of a standard hand truck.

### CROSS-REFERENCE TO RELATED APPLICATIONS

This application claims priority to, and the benefit of, U.S. Provisional Application No. 63/731,519, filed May 14, 2024, the content of which is incorporated by reference herein in its entirety.

### TECHNICAL FIELD

The present invention generally relates to pivot and linkage systems and devices for assisted cargo unloading of a standard hand-truck.

### BACKGROUND

Hand trucks (also referred to as a hand trolley, a dolly, or the like) are manual material handling equipment used for a variety of hauling operations. A hand truck is typically a two-wheeled cart with a handle that facilitates the transport of heavy or bulky items. Common features of a hand truck include a vertical frame with a handle at the top and a small flat platform at the bottom where the items are placed. To move the items, the platform is slid under the load/item, the hand truck is tilted back on its wheels, and then the hand truck is rolled forward with the load tilted at an angle.

In some cases, hand trucks may be cumbersome to use, relying on the strength of the user to apply leverage to tilt of the hand truck for movement of the load, and for offloading the item. For proper use of a hand truck, the load must be kept clear of the wheels with the load's center of gravity as low as possible and with the weight carried by the axle, not the handle. The operator should only balance and push. In practice, if the hand truck is used improperly, it can become unsafe, with the most common injuries being slips, trips, falls, back strains and pulls, crushed hands and toes, scraped fingers and knuckles, and collisions. Many of these injuries occur during loading and offloading of a heavy, awkward, or oversized load.

### SUMMARY

The present invention includes hand truck systems and methods for assisted cargo offloading, and kits for retrofitting a hand truck with an assisted cargo off-loading system. Specifically, the invention includes a mechanical off-load cargo mechanism configured to be built into any standard hand truck with minor modification. The working principles and design configurations provide a rugged, durable hand-operated mechanism for safer, easier, and faster offloading of varied cargo loads. The systems of the invention provide for facilitating offloading of any cargo load, from the lightest to the heaviest loads, that improves the efficiency and safety of hand truck operation.

In particular, by means of operating the handle lever of the mechanical mechanism, with its working linkage and pivots, the operator is easily able to offload the hand truck of boxes or any load items safely, eliminating the work of offloading the items by hand. In practice, and according to one embodiment of the invention, the operator, having brought his hand truck cargo load to his destination and with the hand truck in its upright position, grips the hand truck frame handle with one hand and the convenient operators handle of the mechanism with the other, (located at the upper part of the frames backside.) With the inherent leverage of the operators handle, the operator pulls the pivoted handle downward, which, by virtue of the pulling the operators handle, puts in motion the entire mechanical mechanism. A frontal offload cargo push plate on the nose plate moves forward, pushing the load forward and off the hand truck. The operator is in full control of the hand truck and the cargo, the hand truck being stable, insuring safety and the unloading procedure to be smooth.

Further, and simultaneously, as part of the mechanism, a pair of small 3½ inch wheels mounted on linkage rotate on pivot points, secured to a left and right side bracket plate. The wheels have a centipede thread pattern, which grip and pull as they engage the ground surface, lifting and angling the hand truck and tipping it forward. The tipping angle may be, for example, approximately 8-12 degrees. The hand truck is thereby pulled back and out from under the load. With the offloading complete, the operator may move the handle back via the function of built in torsion springs, such that the mechanical mechanism is returned to its original position.

In this way, it is an aim of the invention that the off-load cargo mechanism used on hand trucks will benefit people, businesses, commerce and society. For example, the invention provides continuous time and work savings by increasing the efficiency of the offloading procedure by casing the work and/or handling involved with unloading items. In this way, the invention also provides for minimizing injury and/or the risk of injury by reducing the risk of lifting and twisting back injury and strains and other injury associated with lifting, and moving heavy loads. This includes reducing fatigue by reducing or eliminating material handling associated with offloading hand trucks by hand. Further, the invention reduces cargo damage and breaking by reducing the amount of manual labor necessary for offloading cargo. Currently, with hand truck use, the hand truck load is offloaded by hand labor. On occasion, the operator may try to push or tip the hand truck or wiggle the load back and forth and from side to side, to try to pull the hand truck backwards and out from under the load. This action can often result in stacked boxes and various cargo toppling over, causing damage, breakage and spillage. Loss of cargo items are a loss to businesses and become expensive to replace and problematic with the amount of time necessary for addressing the issue. The mechanical off-load cargo mechanism of the present invention can help to reduce these cargo damage and spillage problems, by keeping the hand truck stable and safe during the offloading of cargo, and providing an easier offload of the cargo. The benefits of a hand truck with the off-load cargo mechanism of the present invention are numerous, ongoing, and continuous.

The design configuration of the mechanical off-load cargo mechanisms of the invention may be adapted to all types of hand trucks during manufacture. The invention also provides kits for retrofitting any previously built hand trucks. The mechanical mechanism may be adapted to other areas of usage yet to be realized, for example, the push-off plate may be configured as a curved push-off plate with pivot points to accommodate the loading, moving, and offloading of barrels and other round items. Further, the mechanical operating leverage handle, also referred to herein as the “operators handle”, “handle”, “handle lever”, and “pivot handle”, may be mounted either on the right or left side.

Aspects of the invention provide cargo offloading assemblies configured to be operably coupled to a hand truck for facilitating offloading of cargo from the hand truck. The assembly includes a user-operated lever configured to rotate between a default position, in which the lever is substantially aligned with a side frame portion of the hand truck, and an offload position, in which the lever is substantially orthogonal to the side frame portion of the hand truck. The assembly further includes a pair of lift wheels operably coupled to the user-operated lever, wherein the pair of lift wheels are configured to move between a disengaged position when the lever is in a default position and an engaged position when the lever is in the offload position, wherein, when in the engaged position, the pair of lift wheels are configured to engage a ground surface to thereby lift a rear portion of the hand truck at an angle relative to the ground surface. The assembly further includes a push plate positioned adjacent to a nose plate of the hand truck and operably coupled to the user-operated lever, wherein the push plate is configured to translate a length of the nose plate from a resting position when the lever is in the default position, in which the push plate is positioned closer to a rear portion of the nose plate such that a majority of the nose plate is unobstructed and available to receive cargo, and an extended position when the lever is in the default position, in which the push plate is positioned adjacent to an edge of the nose plate so as to engage any cargo loaded on the nose plate and push said cargo off of the nose plate.

The user-operated lever may generally include a handle portion at a proximal end thereof. The user-operated lever may include a distal end rotatably coupled to a support plate connected to the side frame portion of the hand truck.

In some embodiments, a portion of the distal end of the user-operated lever is pivotably coupled to a pair of linkage members, wherein a first one of the pair of linkage members is positioned relative to a right side frame portion of the hand truck and a second one of the pair of linkage members is positioned relative to a left side frame portion of the hand truck. The pair of linkage members may be coupled to one another via a connector member to thereby allow the pair of linkage members to correspondingly move with one another upon rotation of the user-operated lever between the default and offload positions.

In some embodiments, the pair of lift wheels may be operably coupled to the pair of linkage members such that movement of the pair of linkage members, upon rotation of the user-operated lever between the default and offload positions, causes corresponding movement of the pair of lift wheels between the disengaged and engaged positions. In some embodiments, the push plate is operably coupled to the pair of linkage members such that movement of the pair of linkage members, upon rotation of the user-operated lever between the default and offload positions, causes corresponding movement of the push plate between the resting and extended positions.

In some embodiments, the pair of lift wheels are positioned adjacent to a lower rear portion of the hand truck. In some embodiments, a first one of the pair of lift wheels is positioned relative to a right wheel of the hand truck and a second one of the pair of lift wheels is positioned relative to a left wheel of the hand truck. When in the disengaged position, the pair of lift wheels are maintained a distance above the ground surface such that the pair of wheels of the hand truck are maintained in contact with the ground surface. When in the engaged position, the pair of lift wheels engage the ground surface to thereby transfer weight of the hand truck and any cargo provided thereon from the pair of wheels of the hand truck to the pair of lift wheels.

In some embodiments, the pair of lift wheels are configured to move between the disengaged and engaged positions in an arc-like movement. For example, the pair of lift wheels may be operably coupled to the user-operated lever via a V-shaped wheel linkage member. As the pair of lift wheels engage the ground surface, the pair of lift wheels cause the rear portion of the hand truck to rise and thus tip towards the nose plate. In some embodiments, each of the pair of lift wheels comprises a centipede thread pattern to provide gripping and pulling capabilities when engaging a ground surface.

In some embodiments, the push plate comprises a substantially planar surface, while in other embodiments, the push plate comprises an arcuate surface.

### BRIEF DESCRIPTION OF THE DRAWINGS

FIG. 1 illustrates a front view of a hand truck with a mechanical off-load cargo mechanism according to one embodiment of the invention.

FIG. 2 illustrates a rear view of a hand truck with a mechanical off-load cargo mechanism according to one embodiment of the invention.

FIG. 3 illustrates a rear view of a hand truck with a mechanical off-load cargo mechanism according to one embodiment of the invention, and defines Sections A-A (upper mechanical section) and B-B (lower mechanical section) for further illustration.

FIG. 4 is a three-dimensional view of the upper mechanical section (Section View A-A of FIG. 3), according to one embodiment of the invention.

FIG. 5 is a three-dimensional view of the lower mechanical section (Section View B-B of FIG. 3), according to one embodiment of the invention.

FIG. 6 illustrates a connection steel tubing, connector, and pivot linkage of the lower mechanical off-load cargo mechanism according to one embodiment of the invention.

FIG. 7 illustrates a right side detail view of the connector rotation (connector steel tubing, connector, and pivot linkage) at the start of the off-load cargo procedure and at the completion of the off-load cargo procedure according to one embodiment of the invention.

FIG. 8 illustrates a three-dimensional exploded view of a partial assembly of the lower mechanical mechanism (Section View B-B of FIG. 3, FIGS. 5 and 6), illustrating the connector, tubing, pivot linkage, and centipede wheel according to one embodiment of the invention.

FIG. 9 illustrates a rear view of a mechanical off-load cargo mechanism according to one embodiment of the invention and defines a Section View (A-A) for describing operation of the mechanical off-load cargo mechanism.

FIG. 10 illustrates a mode of action of the mechanical off-load cargo mechanism on a hand truck in operation, according to one embodiment of the invention (Section View A-A of FIG. 9).

FIG. 11 illustrates the mechanical mechanism and linkage at a start of the off-load procedure (Section View A-A of FIG. 9), according to one embodiment of the invention.

FIG. 12 illustrates mechanical mechanism and linkage at the completed off-load procedures (Section View B-B of inset of FIG. 12) according to one embodiment of the invention.

FIG. 13 illustrates the mechanical mechanism and linkage according to Section View C-C of the inset of FIG. 13, according to one embodiment of the invention, at the start of the off-load procedure.

FIG. 14 illustrates the mechanical mechanism and linkage according to Section View D-D of FIGS. 14, according to one embodiment of the invention, at the completion of the off-load procedure.

### DETAILED DESCRIPTION

The present invention is directed to hand truck systems and methods for assisted cargo offloading, and kits for retrofitting a hand truck with an assisted cargo off-loading system. Specifically, the invention includes a mechanical off-load cargo mechanism configured to be built into any standard hand truck with minor modification. The working principles and design configurations provide a rugged, durable hand-operated mechanism for safer, easier, and faster offloading of varied cargo loads. The systems of the invention provide for facilitating offloading of any cargo load, from the lightest to the heaviest loads, that improves the efficiency and safety of hand truck operation.

### Assemblies and Systems for Assisted Cargo Offloading

Aspects of the invention provide cargo offloading systems and assemblies for facilitating offloading of cargo from a hand truck.

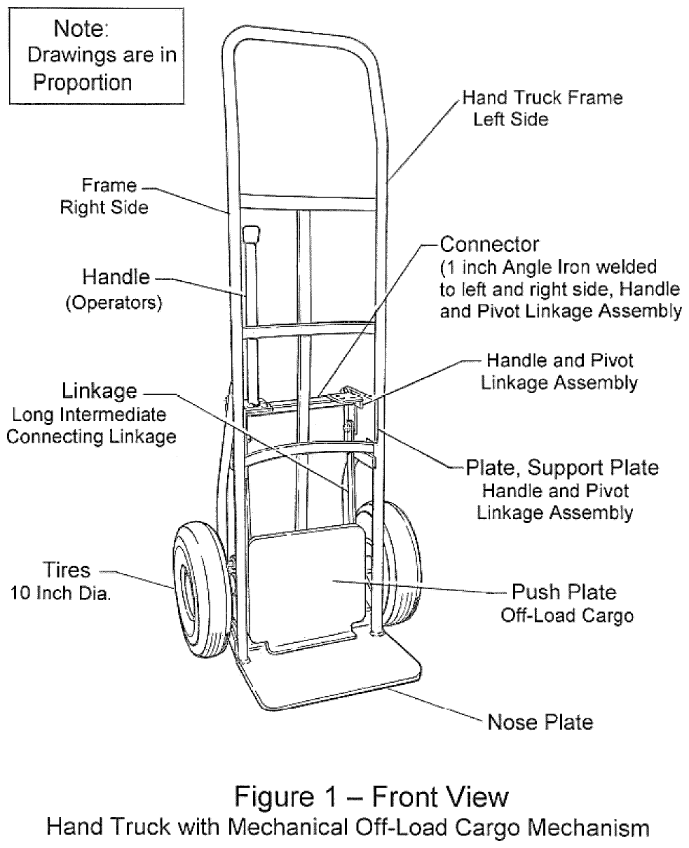

FIG. 1 illustrates a front view of a hand truck with a mechanical off-load cargo mechanism according to one embodiment of the invention. As is known to persons skilled in the art, a standard hand truck may include a frame having a left side and a right side, as viewed from behind the hand truck. The hand truck includes two tires coupled to an axle positioned at a bottom of the frame such that the tires are positioned as one outside the left side frame and one outside the right side frame at the bottom of the frame. The hand truck includes a nose plate extending from the bottom of the frame from the front of the hand truck. The hand truck frame may include one or more supports tying the left side and the right side together, as well as curved top that may be used as a handle. The hand truck may have an integrated handle.

The mechanical off-load system of the present invention is designed to be fitted to a hand truck either during manufacture of the hand truck or retrofitted to an already-manufactured hand truck. As illustrated in FIG. 1, the mechanical off-load system may include frame comprising a one or more connectors to couple the system to the left side and right side of the hand truck frame. For example, the connector may be 1-inch angle iron welded to the left and right sides of the hand truck frame. As described in more detail herein, the mechanical off-load system may include an operators handle and a handle and pivot linkage assembly. The handle may be configured to actuate movement of the off-load system to assist the offloading of cargo. The system may include a push plate positioned at a bottom of the hand truck and configured, upon actuation by the handle, to push the load off the nose plate. The push plate may be coupled to a long, intermediate connecting linkage connecting the handle to the push plate.

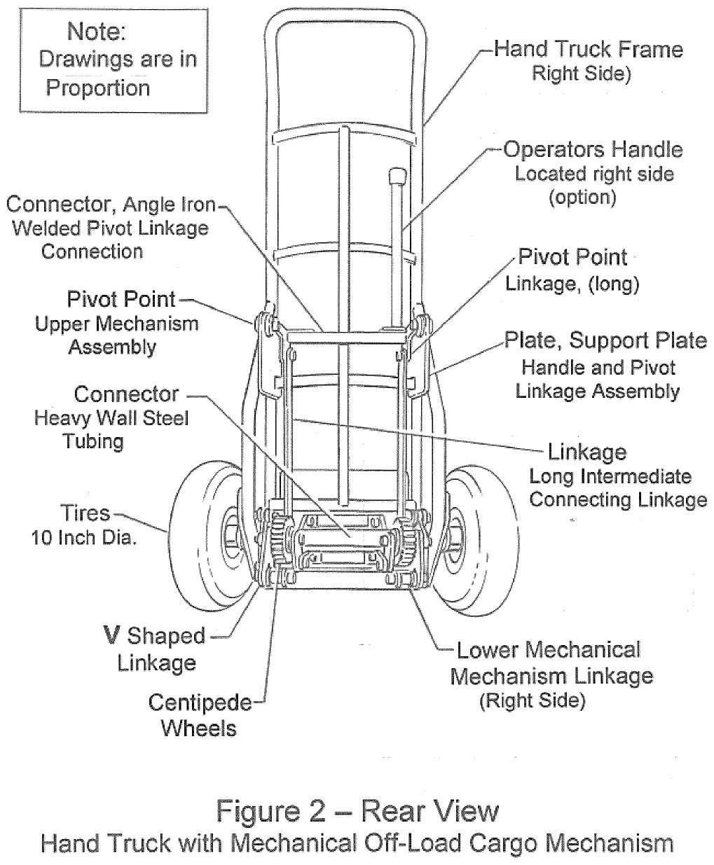

FIG. 2 illustrates a rear view of a hand truck with a mechanical off-load cargo mechanism according to one embodiment of the invention. For reference, FIG. 2 illustrates the right side of the hand truck frame and the left side of the hand truck frame as viewed from the rear or behind the hand truck. As used herein, the terms rear, backside, or behind are meant to describe the position of the hand truck from the perspective of the operator when operating/pushing the hand truck.

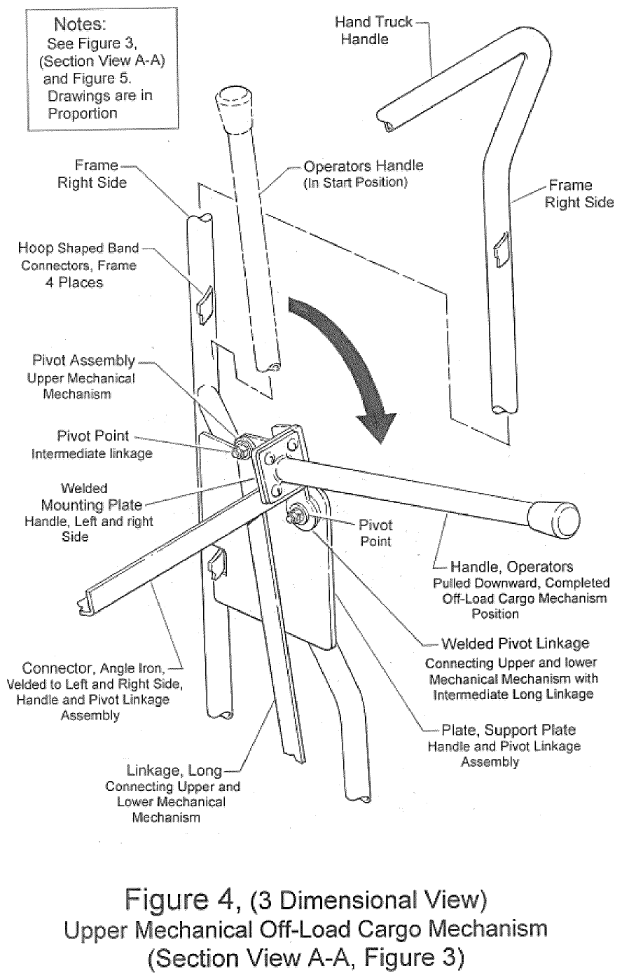

The mechanical off-loading system may include an upper mechanical mechanism (upper mechanism) and a lower mechanical mechanism (lower mechanism). Both the upper and lower mechanisms have a duplicate right and left side. The upper mechanism may include a means for connecting the system to the frame of the hand truck. For example, the connecting means may be angle iron welded to the frame of the hand truck. The right and left side of the upper mechanism may be connected by a welded angle iron connector, as illustrated in FIG. 4. A handy, small, identical plate may also be welded on both sides. This allows for the operator's handle to be easily mounted on either side. The connecting means may include a pivot linkage connection. The pivot linkage connection may be a welded connection.

As illustrated in FIG. 2, the mechanical off-load system includes an operators handle. The handle may be located on a right side of the hand truck, in some embodiments. The handle may be positioned at or near the left side of the hand truck. The handle may be position at any location on the back side, sides, or front of the hand truck suitable for case of operator use of the handle.

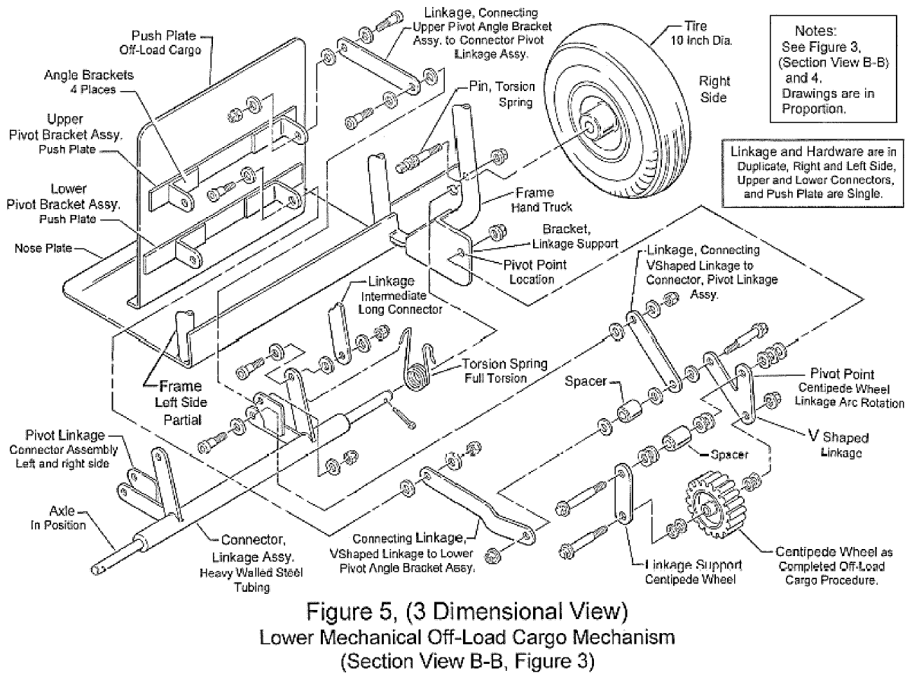

The right and left sides of the lower mechanical mechanism may be connected by a heavy walled steel tubing connector that rotates around the tire axle of the hand truck. Linkage and associated components may be duplicated on the right and left side and welded to the pivot linkage on the connector. (See for example, FIGS. 5, 6, and 8). As part of the working principal and design configuration these two connectors play an important role in the overall “Mode of Action” of the mechanical off-loading cargo mechanism. Its strength and structural integrity supports a smooth, safe, continuous working operating Mechanism.

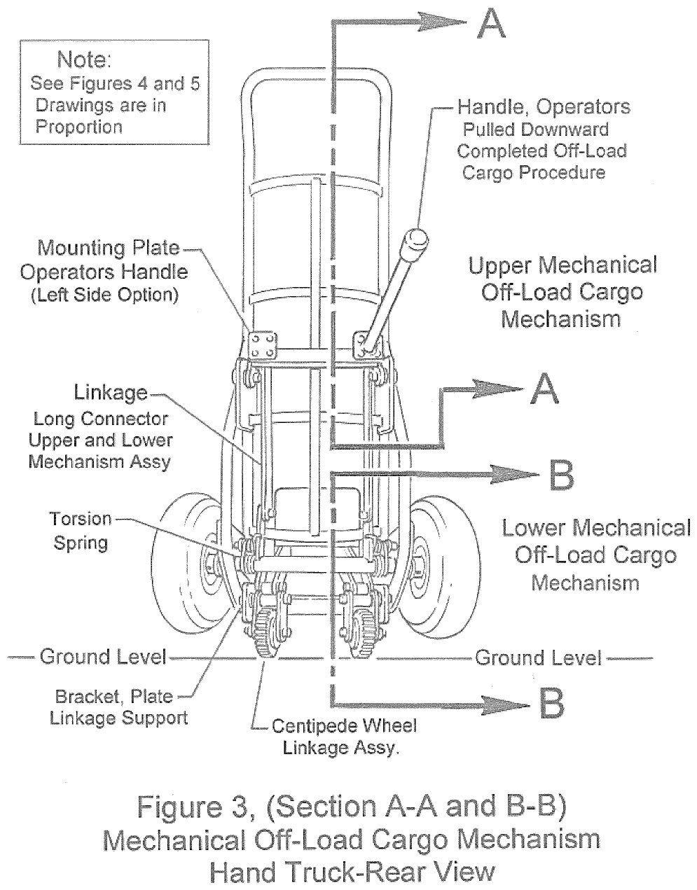

The upper mechanism and the lower mechanism may be connected by a long intermediate connecting linkage, on the left and right side. (See FIGS. 3, and 4).

As disclosed in more detail herein, the lower mechanism may include centipede wheels and a V-shaped linkage. As the operator pulls the handle downward, the centipede wheels (located in the wheel well area) begin to sweep in an arc downward outside the diameter of the hand truck Tires. The centipede wheels continue to sweep downward on its linkage pivot point towards ground 1, with both wheels in unison.

FIG. 3 illustrates a rear view of a hand truck with a mechanical off-load cargo mechanism according to one embodiment of the invention, and defines Sections A-A (upper mechanical section) and B-B (lower mechanical section) for further illustration. As illustrated in FIG. 3, the upper mechanism may include one or more mounting plates to which the operator's handle is connected. The handle includes a linkage to the lower mechanism and the push plate and centipede wheels. The linkage may be a long connector coupling the upper and lower mechanism assemblies. The linkage may include a torsion spring coupled to the bottom of the linkage. In operation, when the operator pulls the operator's handle downward, the linkage of the handle to the lower mechanism actuates movement of the centipede wheels to ground level and movement of the push plate to offload the cargo positioned on the hand truck nose plate.

FIG. 4 is a three-dimensional view of the upper mechanical section (Section View A-A of FIG. 3), according to one embodiment of the invention. The upper mechanical section (also referred to herein as the upper mechanism) may include handle (also referred to herein as an operator's handle) attached to the system via a pivot assembly. The pivot assembly may include a welded pivot linkages connecting the upper and lower mechanisms with the intermediate long linkage. The intermediate long linkage connects the upper and lower mechanisms. The welded mounting plate may be connected to, for example, an angle iron welded to the left and right side of the handle and pivot linkage assembly. The handle may be operable to be pulled downward (or upward) from a neutral vertical position to actuate the various linkages of the system. For example, the handle may be in a substantially vertical start position and may be pulled backward and downward by the operator to actuate the linkages.

The lower mechanism may include a centipede wheel linkage assembly. In some embodiments, one side of the centipede wheel linkage assembly may include a wheel support that distinctly shaped as a “V”. The pivot point of this V-shaped linkage may be on a bracket welded or bolted into the frame of the hand truck. The bracket may include a linkage support such as bolt or other connector. The lower mechanism may include a support linkage forming a yoke-like fabrication with the V-shaped linkage, located on the opposite side of the V-shaped linkage. (See FIG. 5).

FIG. 5 is a three-dimensional exploded view of the lower mechanical section (Section View B-B of FIG. 3), according to one embodiment of the invention. As illustrated in detail in FIG. 5, the lower mechanical section, also referred to as the lower mechanism, may include a push plate for offloading cargo. The push plate may be moveably positioned on top of the nose plate of the hand truck. A back side of the push plate may include one or more of an upper pivot bracket assembly and a lower pivot bracket assembly. The upper and lower pivot bracket assemblies may include one or more angle brackets. The angle brackets of the upper pivot bracket assembly may be connected to a linkage or plate connecting the upper pivot angle bracket assembly to the connector pivot linkage assembly. The connector linkage assembly may be a heavy walled steel tube connecting the linkage assembly to the frame of the hand truck and the axle of the hand truck wheel. The connector linkage assembly may include a connection to the intermediate long connector linkage. The linkage connector assembly may include one or more torsion springs at the end or ends of the connector linkage assembly/assemblies. As illustrate in FIG. 5, an axle position of the connector linkage assembly may align with the axle of the hand truck tires.

The lower mechanism includes a linkage connecting the V-shaped linkage to the pivot linkage connector assembly. The V-shaped linkage may be a pivot point for the centipede wheel. The centipede wheel may be connected to the V-shaped linkage. The connection may include one or more spacers and a linkage support for the centipede wheel. The V-shaped linkage may be connect to the lower pivot angle bracket via a connecting linkage. In some embodiments, the linkage and hardware of the lower mechanism are in duplicate between the right and left sides of the lower mechanism and the upper and lower connections. The connectors of the push plate may be in single.

The centipede wheel as shown in FIG. 5 is in a completed off-load cargo position. The centipede wheel may include a linkage support for the centipede wheel.

Thus, in some embodiments, the lower part of the off-load cargo push plate and on the back side of the push plate may be connected by linkage to the pivot and arc of the centipede wheels. The upper part of the off-load cargo push plate and on the backside may be connected by linkage to pivot linkage that had been welded to the heavy walled steel tubing connector, rotating on the axle of the hand truck. These pivot and linkage connections ensure a straight even movement of the off-load cargo push plate as it is pushing the cargo load off the nose plate. (See FIG. 5).

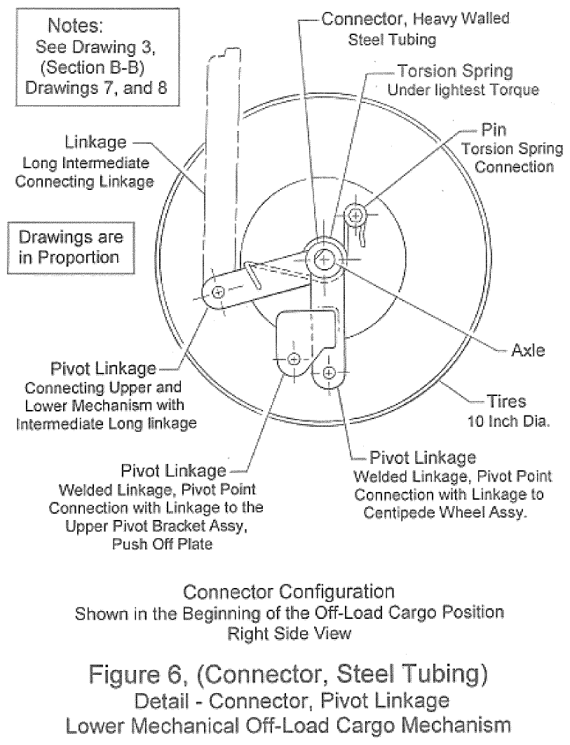

FIG. 6 illustrates a steel tubing connector, and pivot linkage of the lower mechanical off-load cargo mechanism according to one embodiment of the invention. The connector may be, for example, heavy walled steel tubing. The connector may be connected to the axle of the hand truck. The connector may include a torsion spring on one or both ends. The torsion spring may include a pin as a torsion spring connection. The tubing connector may include a pivot linkage. The pivot linkage may be a welded linkage configured as a pivot point connection with linkage to the centipede wheel assembly. The pivot linkage may include a second pivot linkage also comprising a welded linkage serving as a pivot point connection with linkage to the upper pivot bracket assembly and push off plate. The tubing connector may include a third pivot linkage connecting the upper and lower mechanism with the intermediate long linkage.

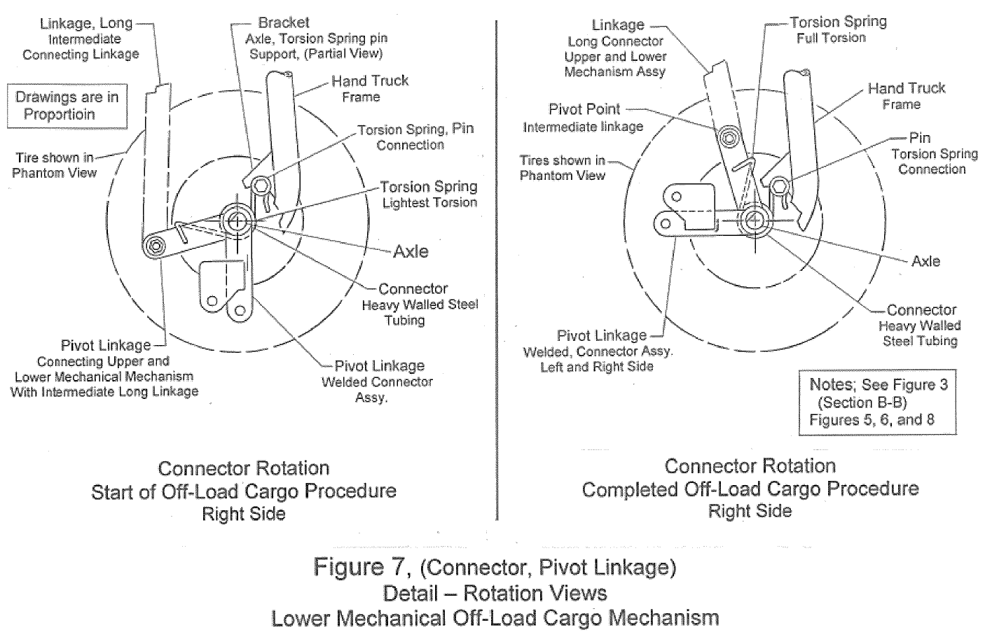

FIG. 7 (left panel) illustrates a right side detail view of the connector rotation (connector steel tubing, connector, and pivot linkage) at the start of the off-load cargo procedure and at the completion of the off-load cargo procedure according to one embodiment of the invention. The long intermediate connecting linkage may be connected to the pivot linkage of the lower mechanical mechanism. The pivot linkage of the lower mechanism connects the upper and lower mechanisms with the intermediate long linkage. The pivot linkage (connected to the heavy walled steel tubing), axle, torsion spring, torsion spring pin connection, hand truck frame, and partial view of the bracket (axle, torsion spring pin support) are illustrated. The pivot linkage is in a 6:00 position at the start of the off-load cargo procedure. FIG. 7 (right panel) illustrates the connector rotation at the completed off-load cargo procedure. The pivot linkage of the welded connector assembly is in a 9:00 position. As illustrated, the linkages, via actuation of the handle, are rotated as designed to actuate the centipede wheels and lift the hand truck tires from the ground position.

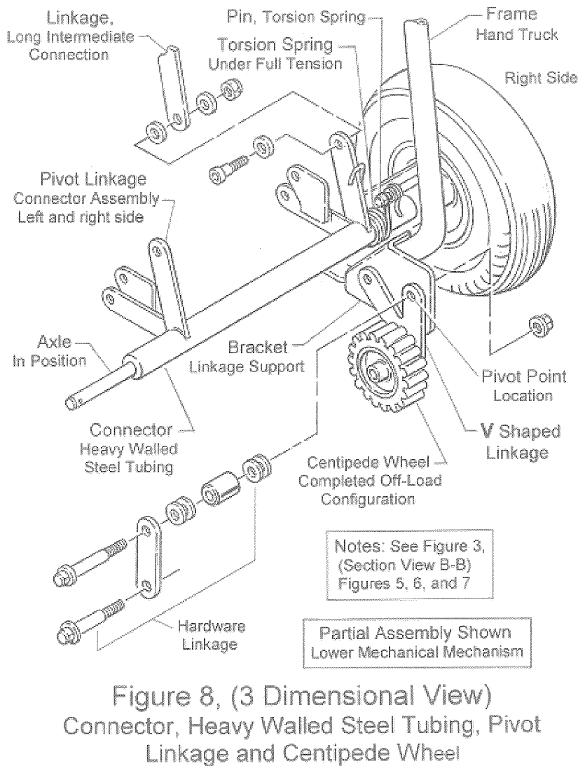

FIG. 8 illustrates a three-dimensional exploded view of a partial assembly of the lower mechanical mechanism (Section View B-B of FIG. 3, FIGS. 5 and 6), illustrating the connector, tubing, pivot linkage, and centipede wheel according to one embodiment of the invention. The centipede wheel is illustrated in the completed off-load configuration as lowered to ground level to lift the hand truck tires from the ground. The torsion spring is illustrated as being under full tensions during actuation of the off-loading procedure.

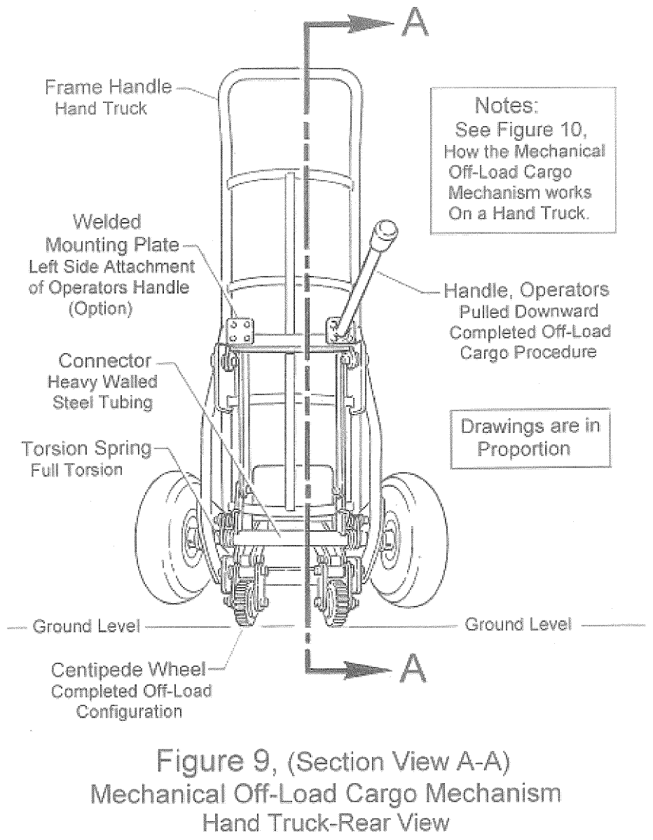

FIG. 9 further illustrates a rear view of a mechanical off-load cargo mechanism according to one embodiment of the invention and defines a Section View (A-A) for describing operation of the mechanical off-load cargo mechanism. In operation, in some embodiments, the mechanical off-load cargo mechanism may be actuated when the operator pulls the handle downward from a vertical position. The pulling movement may be back towards the operator.

The associated linkages are actuated to lower the centipede wheels to ground level, lift the hand truck wheels from a ground level position, and actuate the push plate to offload the cargo.

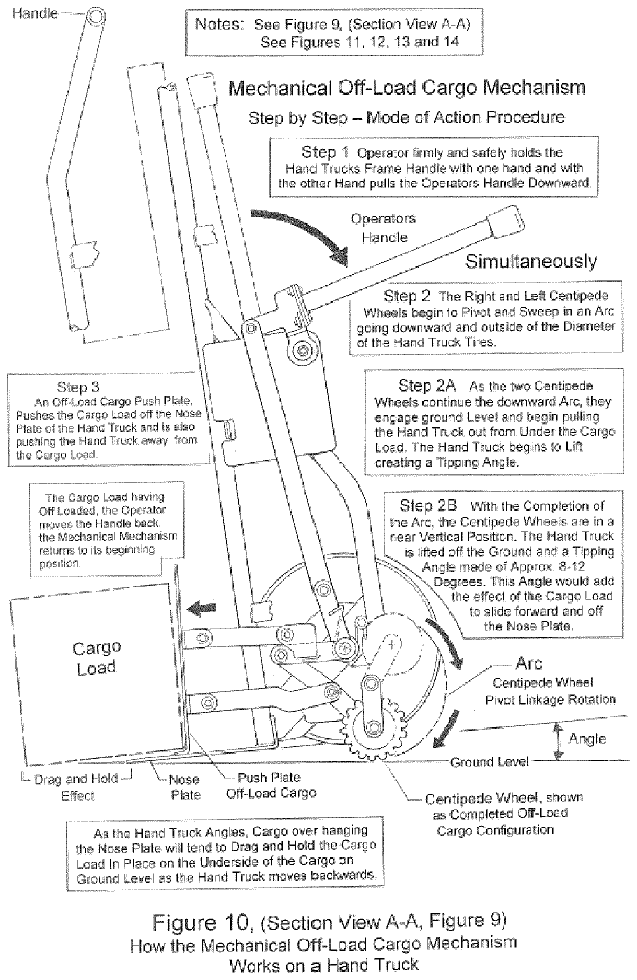

FIG. 10 illustrates a mode of action of the mechanical off-load cargo mechanism on a hand truck in operation, according to one embodiment of the invention (Section View A-A of FIG. 9).

for example, in step 1, the operator, having brought the hand truck cargo load to the destination and with the hand truck in its upright position, may grip and hold the hand truck frame handle firmly and safely with one hand, while moving the operator's handle downward with the other hand. As the operator's handle is moved downward, the lower mechanical off-load cargo mechanism begins to work in unison.

The upper and lower mechanical mechanism may have a duplicate right and left side. On the upper mechanism assembly, the right and left side may be connected by a welded angle iron connector. (See FIG. 4). A handy, small identical plate may also be welded on both sides. This allows the operator's handle to be easily mounted on either side.

As disclosed herein, on the lower mechanical mechanism the right and left side may be connected by a heavy walled steel tubing connector that rotates around the tire axle of the hand truck. Linkage and components are duplicate on the right and left side and welded pivot linkage on the connector. (See FIGS. 5, 6, and 8). As part of the working principal and design configuration these two connectors play an important role in the overall “mode of action” of the mechanical off-load cargo mechanism. The strength and structural integrity of the design of the linkages and connectors supports a smooth, safe, continuous working operating mechanism. The upper and lower mechanical mechanism may be connected by a long intermediate connecting linkage, on the left and right side. (see FIGS. 3, and 4).

Step 2 may include, as the operator pulls the handle downward, the centipede wheels (located in the wheel well area) begin to sweep in an arc downward out-side the diameter of the hand truck tires. The centipede wheels continue to sweep downward on its linkage pivot point towards ground level (both wheels are in unison). As disclosed herein, one side of the centipede wheel linkage, supporting the wheel may be distinctly shaped as a v. The pivot point of this v-shaped linkage may be on a bracket welded or bolted into the frame of the hand truck. There may be support linkage forming a yoke like fabrication with the v-shaped linkage, located on the opposite side of the v-shaped linkage. (see FIG. 5).

As the centipede wheels engage ground level, they begin to “lift” and pull backwards the entire hand truck. In operation, as the centipede wheels engage ground level, they may begin to lift and pull backwards the entire hand truck. As the arc continues to rotate on its pivot point, the centipede wheels pull the hand truck out from under the cargo load. With completion of the arc, the centipede wheels may be in a near vertical standing position. As illustrated in FIG. 10, the large 10 inch hand truck tires are off the ground, and a tipping angle to the end of the nose plate has been created. This tipping angle may be, for example, 8 to 15 degrees. This tipping angle may also have a desired effect of the cargo load wanting to slide off the nose plate of the hand truck for case of off-loading.

Step 3 may include the off-load cargo push plate, located at the front of the hand truck on the hand truck nose plate, moving forward, in unison, pushing the cargo load off the nose plate. As the off-load cargo push plate pushes the cargo load off the nose plate it may be also simultaneously helping to push the hand truck backwards and out from under the cargo load. As the push plate moves to push the cargo load off the nose plate and the hand truck backwards, the centipede wheels work to pull the hand truck out from under the cargo load and create the tipping angle.

Depending on a cargo load size, shape and weight, and as the tipping angle develops, any overhang off the end of the nose plate would tend to drag and hold a cargo load. This drag and hold effect would be on the underside of a cargo load at ground level, increasing as the angle is completed, and the hand truck is being pulled out from under the cargo load. It is well to mention that the off-load cargo mechanism principles operating together, all play a role in the completion of the cargo off-load procedure. Further, the cargo off-load push plate is not only pushing the cargo load forward and off the nose plate, by the working principles and design configuration of the mechanical mechanism, it is also pushing the entire hand truck back and away, as the centipede wheels are pulling the hand truck out from under the cargo load.

This “mode of action” of the centipede wheels and the hand truck being pulled out from under the cargo load lessens the effect of the weight of the cargo that is being pushed off the nose plate. Thus, an important aspect of the invention of this mechanical off-load cargo mechanism, is that it has the ability to off-load the heaviest cargo with the least effort. For example, if there was a reliance only of a push plate pushing and off-loading the cargo, reaching a certain weight thresh hold, the weight of the cargo could prevent the operator from being able to push that cargo off the nose plate. However, with the current invention, and the off-loading cargo principles of the design of the systems of the invention working together in unison with each other, the weight from the cargo load may be distributed among the off-load procedure principles. Thus, the inherent working principles and design configuration of the hand truck, being pulled out from under a cargo load greatly reduces the influence of weight with the off-load cargo mechanism. This enables the systems of the invention to provide a mechanism for safer, more stable, and casier off-loading cargo tasks.

Once the off-loading of cargo is complete, the operator moves the handle back and in unison the mechanical mechanism returns to its beginning position.

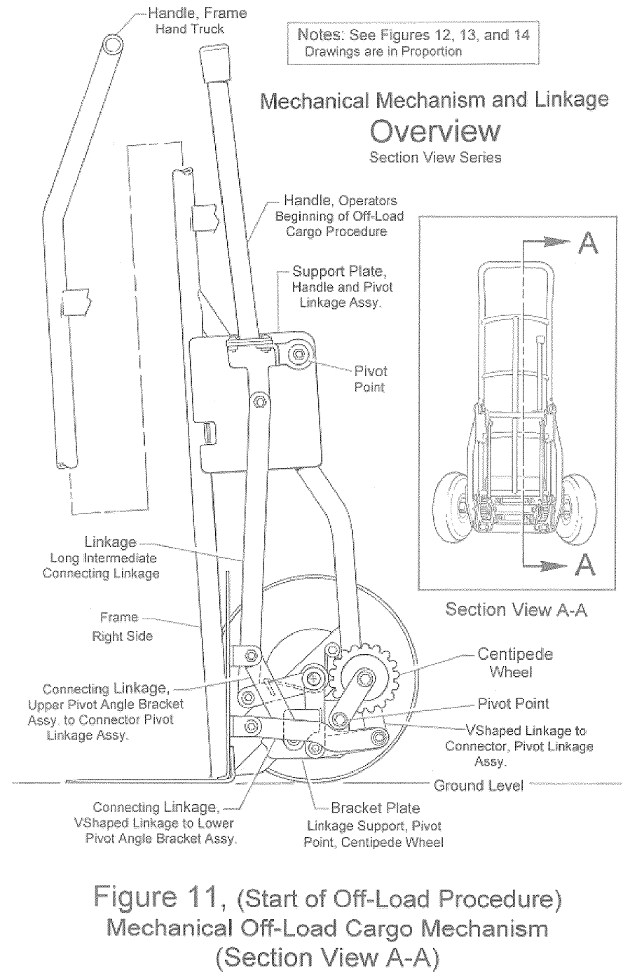

FIG. 11 illustrates the mechanical mechanism and the various linkages at a start of the off-load procedure (Section View A-A of FIG. 9), according to one embodiment of the invention. As illustrated, the operator's handle may be in a substantially vertical position at the beginning of the off-loading of cargo procedure. As disclosed herein, the upper mechanism includes a support plate and handle and pivot linkage assembly. This linkage may be operably connected to a long intermediate connecting linkage connecting the upper mechanism to the lower mechanism. The lower mechanism may be connected to the hand truck frame. The lower mechanism includes a connecting linkage with the long intermediate connecting linkage. The connecting linkage connects the upper pivot angle bracket assembly to the connector pivot linkage assembly. The connecting linkage may include a v-shaped linkage to the lower pivot angle bracket assembly. The bracket plate includes a linkage support, pivot point, and centipede wheel.

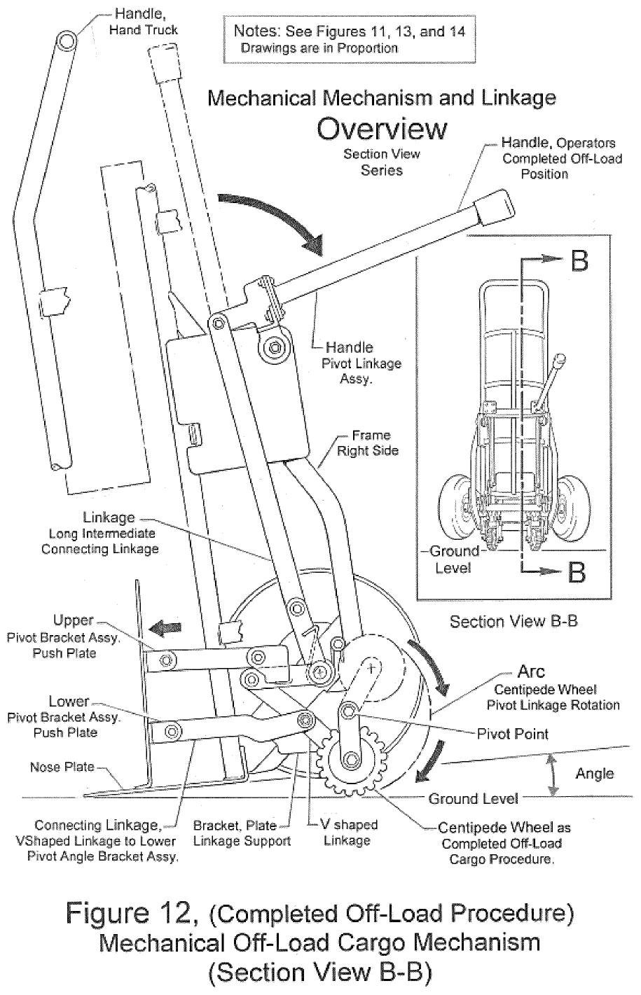

FIG. 12 illustrates a mechanical mechanism and linkage at the completed off-load procedures (Section View B-B of inset of FIG. 12) according to one embodiment of the invention. The handle has been pulled downward to actuate the linkages. Actuation of the linkages, in unison, rotates the centipede wheels to ground level to raise the hand truck wheels off the ground and creating and off-loading angle, and pushes the push plate forward to push the cargo off the hand truck face plate. The rotation and movement of the mechanisms and linkages are illustrated by the arrows in FIG. 12.

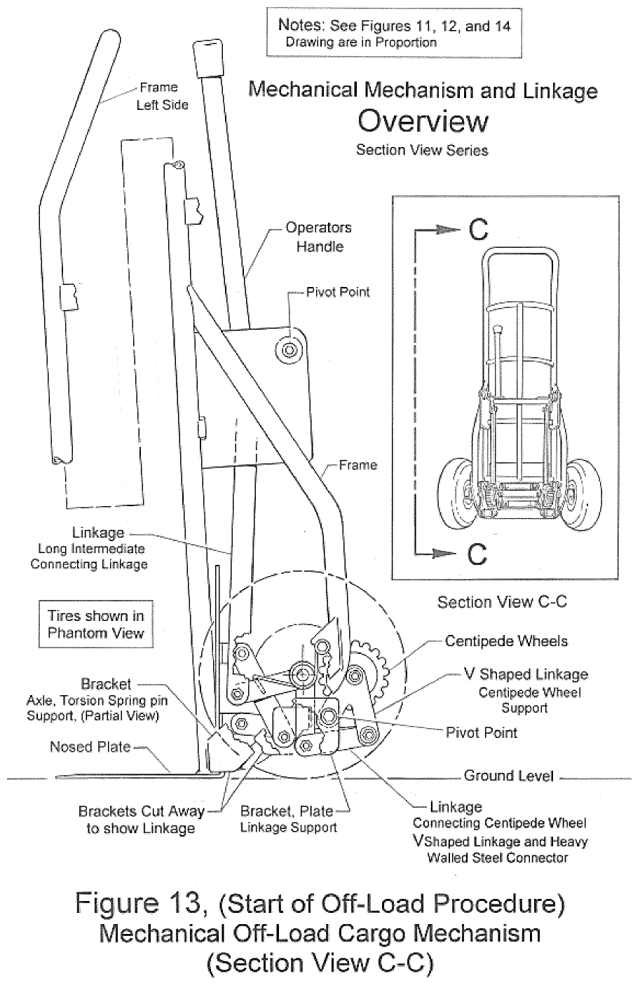

FIG. 13 illustrates the mechanical mechanism and linkage according to Section View C-C of the inset of FIG. 13, according to one embodiment of the invention, at the start of the off-load procedure. In this example, the handle is on the left side of the hand truck and associated linkages adjusted.

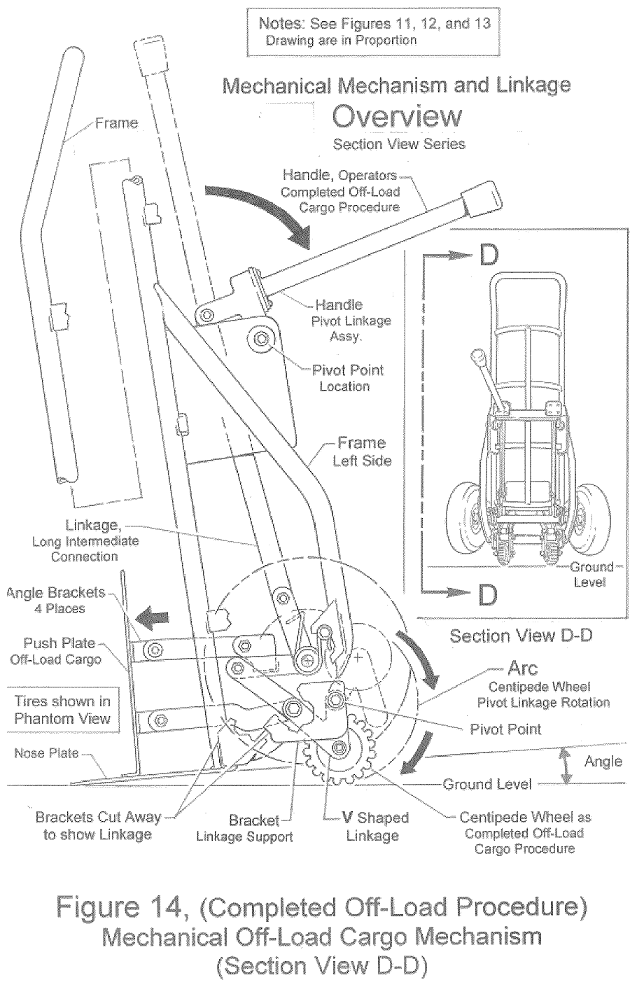

FIG. 14 illustrates the mechanical mechanism and linkage according to Section View D-D of FIG. 14, according to one embodiment of the invention, at the completion of the off-load procedure.

### Method for Assisted Cargo Offloading

Aspects of the invention provide methods for offloading cargo from a hand truck using systems of the invention.

As illustrated in FIG. 10, the method includes the operator bringing the hand truck with a cargo load to a desired destination. With the hand truck in its upright position, the operator may grip and hold the hand truck frame/handle firmly and safely with one hand, and with the other hand, move the operator's handle of the systems of the invention back towards the operator and downward. As this action happens, the lower mechanism works in unison with the movement of the handle. As the operator pulls the operator's handle downward, the centipede wheels (located in the wheel well area) begin to sweep in an arc downward out-side the diameter of the hand truck tires. The centipede wheels continue to sweep downward on its linkage pivot point towards ground level (both wheels are in unison). As the centipede wheels engage ground level, they begin to “lift” and pull backwards the entire hand truck. As the arc continues to rotate on its pivot point, the centipede wheels pull the hand truck out from under the cargo load.

With the completion of the arc, the centipede wheels are in a near vertical standing position. As illustrated, the large 10 inch hand truck tires are off the ground, and a tipping angle to the end of the nose plate has been created. The tipping angle may be, for example, 8 to 15 degrees. This tipping angle may have the desired effect of the cargo load wanting to slide off the nose plate of the hand truck.

At the front of the hand truck, an off-load cargo push plate, located on the nose plate, moves forward in unison, pushing the cargo load off the nose plate. The lower part of the off-load cargo push plate and on the backside may be connected by linkage to the pivot and arc of the centipede wheels. The upper part of the off-load cargo push plate and on the backside may be connected by linkage to pivot linkage that had been welded to the heavy walled steel tubing connector, rotating on the axle of the hand truck. These pivot and linkage connections ensure a straight even movement of the off-load cargo push plate as it is pushing the cargo load off the nose plate.

As the off-load cargo push plate is pushing the cargo load off the nose plate it is also simultaneously helping to push the hand truck backwards and out from under the cargo load. As the push plate is moving to push the cargo load off the nose plate and the hand truck backwards, the centipede wheels are working to pull the hand truck out from under the cargo load and creates the tipping angle.

Depending on the cargo load size, shape, and weight, and as the tipping angle develops, any overhang off the end of the nose plate would tend to drag and hold a cargo load. This drag and hold effect would be on the underside of a cargo load at ground level, increasing as the angle is completed, and the hand truck is being pulled out from under the cargo load. It is well to mention that the off-load cargo mechanism principles operating together, all play a role in the completion of the cargo off-load procedure. Further, the cargo off-load push plate is not only pushing the cargo load forward and off the nose plate, by the working principles and design configuration of the mechanical mechanism, it is also pushing the entire hand truck back and away, as the centipede wheels are pulling the hand truck out from under the cargo load.

The “mode of action” of the centipede wheels and the hand truck being pulled out from under the cargo load lessens the effect of the weight of the cargo that is being pushed off the nose plate. An important goal of the inventor of this mechanical off-load cargo mechanism, was for it to have the ability to off-load the heaviest cargo with the least effort. If there was a reliance only of a push plate pushing and off-loading the cargo, reaching a certain weight thresh hold, the weight could prevent the operator from being able to push that cargo off the nose plate. However, with these off-loading cargo principles working in unison with each other, the weight from the cargo load is distributed among the off-load procedure principles. The inherent working principles and design configuration of the hand truck, being pulled out from under a cargo load greatly reduces the influence of weight with the off-load cargo mechanism.

The offloading cargo task being safer, stable, and casier.

The cargo having been off-loaded, the operator moves the handle back and in unison the mechanical mechanism return to its beginning position.

### Kits for Retrofitting a Hank Truck with an Assembly/System for Assisted Cargo Offloading

Aspects of the invention may include kits (i.e., prepackaged components) for retrofitting a hand truck with an assembly or system of the invention, such as an assembly described herein and illustrated in the figures. The kit may include the assembly as described herein (and illustrated in the figures) with associated nuts, bolts, washers, connectors, clamps, and the like to releasably or unreleasably attach the assembly components (i.e. upper mechanism, lower mechanism, user-operated lever, pair of lift wheels, push plate, etc.) to a hand truck.

### Incorporation by Reference

References and citations to other documents, such as patents, patent applications, patent publications, journals, books, papers, web contents, have been made throughout this disclosure. All such documents are hereby incorporated herein by reference in their entirety for all purposes.

### Equivalents

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. A cargo offloading assembly configured to be operably coupled to a hand truck for facilitating offloading of cargo from the hand truck, the assembly comprising:
a user-operated lever configured to rotate between a default position, in which the lever is substantially aligned with a side frame portion of the hand truck, and an offload position, in which the lever is substantially orthogonal to the side frame portion of the hand truck;
a pair of lift wheels operably coupled to the user-operated lever, wherein the pair of lift wheels are configured to move between a disengaged position when the lever is in a default position and an engaged position when the lever is in the offload position, wherein, when in the engaged position, the pair of lift wheels are configured to engage a ground surface to thereby lift a rear portion of the hand truck at an angle relative to the ground surface; and
a push plate positioned adjacent to a nose plate of the hand truck and operably coupled to the user-operated lever, wherein the push plate is configured to translate a length of the nose plate from a resting position when the lever is in the default position, in which the push plate is positioned closer to a rear portion of the nose plate such that a majority of the nose plate is unobstructed and available to receive cargo, and an extended position when the lever is in the default position, in which the push plate is positioned adjacent to an edge of the nose plate so as to engage any cargo loaded on the nose plate and push said cargo off of the nose plate.

2. The cargo offloading assembly of claim 1, wherein the user-operated lever comprises a handle portion at a proximal end.

3. The cargo offloading assembly of claim 1, wherein the user-operated lever comprises a distal end rotatably coupled to a support plate connected to the side frame portion of the hand truck.

4. The cargo offloading assembly of claim 3, wherein a portion of the distal end of the user-operated lever is pivotably coupled to a pair of linkage members, wherein a first one of the pair of linkage members is positioned relative to a right side frame portion of the hand truck and a second one of the pair of linkage members is positioned relative to a left side frame portion of the hand truck.

5. The cargo offloading assembly of claim 4, wherein the pair of linkage members are coupled to one another via a connector member to thereby allow the pair of linkage members to correspondingly move with one another upon rotation of the user-operated lever between the default and offload positions.

6. The cargo offloading assembly of claim 4, wherein the pair of lift wheels are operably coupled to the pair of linkage members such that movement of the pair of linkage members, upon rotation of the user-operated lever between the default and offload positions, causes corresponding movement of the pair of lift wheels between the disengaged and engaged positions.

7. The cargo offloading assembly of claim 4, wherein the push plate is operably coupled to the pair of linkage members such that movement of the pair of linkage members, upon rotation of the user-operated lever between the default and offload positions, causes corresponding movement of the push plate between the resting and extended positions.

8. The cargo offloading assembly of claim 1, wherein the pair of lift wheels are positioned adjacent to a lower rear portion of the hand truck.

9. The cargo offloading assembly of claim 8, wherein a first one of the pair of lift wheels is positioned relative to a right wheel of the hand truck and a second one of the pair of lift wheels is positioned relative to a left wheel of the hand truck.

10. The cargo offloading assembly of claim 9, wherein, when in the disengaged position, the pair of lift wheels are maintained a distance above the ground surface such that the pair of wheels of the hand truck are maintained in contact with the ground surface.

11. The cargo offloading assembly of claim 9, wherein, when in the engaged position, the pair of lift wheels engage the ground surface to thereby transfer weight of the hand truck and any cargo provided thereon from the pair of wheels of the hand truck to the pair of lift wheels.

12. The cargo offloading assembly of claim 8, wherein the pair of lift wheels are configured to move between the disengaged and engaged positions in an arc-like movement.

13. The cargo offloading assembly of claim 12, wherein the pair of lift wheels are operably coupled to the user-operated lever via a V-shaped wheel linkage member.

14. The cargo offloading assembly of claim 13, wherein, as the pair of lift wheels engage the ground surface, the pair of lift wheels cause the rear portion of the hand truck to rise and thus tip towards the nose plate.

15. The cargo offloading assembly of claim 1, wherein each of the pair of lift wheels comprises a centipede thread pattern to provide gripping and pulling capabilities when engaging a ground surface.

16. The cargo offloading assembly of claim 1, wherein the push plate comprises a substantially planar surface.

17. The cargo offloading assembly of claim 1, wherein the push plate comprises an arcuate surface.
